(19) United States
(12) Patent Application Publication
(10) Pub. No.: US 2026/0145340 A1
(43) Pub. Date: May 28, 2026

(54) METHODS AND APPARATUS TO DISPENSE HIGH VISCOSITY FLUID WITH A FORMING END EFFECTOR

(71) Applicant: The Boeing Company, Arlington, VA (US)

(72) Inventors: Tayfur Demiral, Mesa, AZ (US); Ashley B. Bruno, Mesa, AZ (US); Michael Robert Mercer, Mesa, AZ (US)

(21) Appl. No.: 18/957,300

(22) Filed: Nov. 22, 2024

(51) Int. Cl. B25J 11/00; B05C 5/02

(52) U.S. Cl. CPC B25J 11/0075; B05C 5/0225

(57) ABSTRACT

Methods and apparatus to dispense high viscosity fluid with a forming end effector are disclosed. An example an applicator includes a tool interface couplable to an arm of a robot, and an end effector supported by the tool interface, the end effector including a contoured surface and an outlet proximate or on the contoured surface, the outlet to dispense fluid therefrom as the end effector is moved such that contact of the contoured surface with the dispensed fluid is to shape the dispensed fluid.

### FIELD OF THE DISCLOSURE

This disclosure relates generally to manufacturing and, more particularly, to methods and apparatus to dispense high viscosity fluid with a forming end effector.

### BACKGROUND

High viscosity sealant is typically applied to parts in a manual process due to its consistency. Manual application of the sealant can introduce human error and, thus, compromise the overall quality of the parts. Further, manual application can be time-consuming and pose ergonomic challenges.

### SUMMARY

An example applicator includes a tool interface couplable to an arm of a robot, and an end effector supported by the tool interface, the end effector including a contoured surface and an outlet proximate or on the contoured surface, the outlet to dispense fluid therefrom as the end effector is moved such that contact of the contoured surface with the dispensed fluid is to shape the dispensed fluid.

An example non-transitory machine readable storage medium includes instructions to cause programmable circuitry to at least determine a parameter of fluid being dispensed from an end effector based on output from a sensor, the end effector supported by a robot arm, the end effector having a contoured surface to shape the dispensed fluid as the end effector is moved, and adjust at least one of the dispensing of the fluid or a rate of movement of the end effector based on the determined parameter.

An example method includes moving an end effector supported by an arm of a robot, and dispensing fluid from an outlet of the end effector, the end effector including a contoured surface proximate the outlet to contact the dispensed fluid to define a swept or rotated shape object of the fluid.

### BRIEF DESCRIPTION OF THE DRAWINGS

FIG. 1 is an example fluid dispensing and shaping system in accordance with teachings of this disclosure.

FIG. 2 is a detailed view of the example fluid dispensing and shaping system of FIG. 1.

FIGS. 3A and 3B are detailed views of the example fluid dispensing and shaping system of FIGS. 1 and 2.

FIGS. 4A-4C are detailed views of an example applicator in accordance with teachings of this disclosure.

FIG. 5 depicts an example manufacturing process flow that can be implemented in examples disclosed herein.

FIG. 6 is a block diagram of an example fluid dispensing control system that can be implemented in examples disclosed herein.

FIG. 7 is a flowchart representative of example machine readable instructions and/or example operations that may be executed, instantiated, and/or performed by example programmable circuitry to implement the fluid dispensing control system 600 of FIG. 6.

FIG. 8 is a block diagram of an example processing platform including programmable circuitry structured to execute, instantiate, and/or perform the example machine readable instructions and/or perform the example operations of FIG. 7 to implement the fluid dispensing control system 600 of FIG. 6.

FIG. 9 is a block diagram of an example implementation of the programmable circuitry of FIG. 8.

FIG. 10 is a block diagram of another example implementation of the programmable circuitry of FIG. 8.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus to dispense high viscosity fluid with a forming end effector are disclosed. In known application/production systems, high viscosity sealant is applied to parts. The sealant is typically applied in a manual process. The manual process can result in voids, air bubbles, inconsistent shapes, etc. In particular, inconsistent pressure, improper technique, or variations in application speed can lead to uneven or inadequate sealant coverage. These resultant imperfections can compromise the overall quality and effectiveness of the sealant. Another challenge with known manual techniques is the time and effort required for manual application, especially for complex or repetitive tasks. Manual application can be labor-intensive and time-consuming, leading to increased production time and costs. Even further, manual application can pose ergonomic challenges.

Examples disclosed herein employ In situ Dispensing and Forming End Effector (IDFEE) as a specialized end effector design approach that can be utilized with relatively small robots, automated gantries, and CNC machines, etc. Examples disclosed herein can effectively dispense and shape high viscosity sealant simultaneously on desired parts, thereby enabling the creation of precise and predetermined shapes. To facilitate an application process of the sealant, at least one internal sealant outlet or channel can be implemented to guide the sealant from a premix frozen syringe to a designated application area.

Examples disclosed herein can be utilized with a robot or other assembly/manufacturing device to dispense highly viscous fluid (e.g., a fluid having greater than or equal to 5,000-10,000 centipoise (cps) of viscosity). Examples disclosed herein include an end effector that can be moved relative to a workpiece. The end effector includes an outlet or channel to dispense the fluid to the workpiece, as well as a contoured surface proximate to the outlet to shape the dispensed fluid. According to some examples disclosed herein, the contoured surface can be moved to shape the dispensed fluid as the dispensed fluid is applied to the workpiece.

In some examples, the end effector is rotated as the fluid is dispensed from the outlet. In some examples, at least one parameter (e.g., a temperature, a pressure, a flow rate, a rate of movement of the end effector, etc.) of the dispensed fluid (e.g., based on a measured parameter, based on a defined structure to be built, etc.) is controlled and/or maintained. In some examples, the end effector includes a curved bladder shape. Additionally or alternatively, a distance between the end effector and the workpiece is maintained as the fluid is dispensed from the end effector.

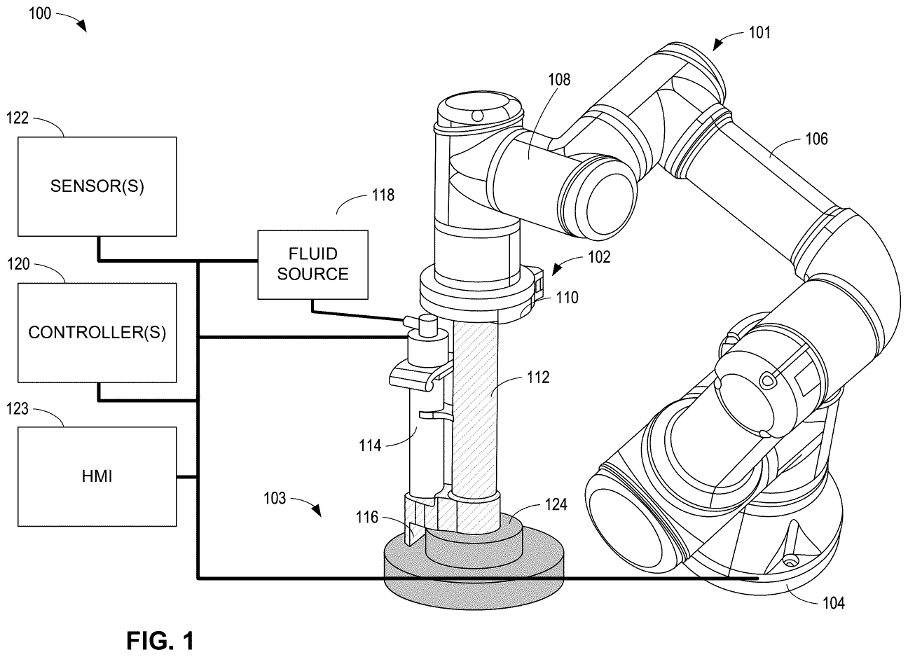

FIG. 1 is an example fluid dispensing and shaping system 100 in accordance with teachings of this disclosure. The fluid dispensing and shaping system 100 of the illustrated example includes a robot 101, and an applicator (e.g., a dispenser, a fluid applicator, a fluid dispenser, etc.) 102 that applies fluid, such as a high viscosity sealant (e.g., a premixed frozen sealant), to a workpiece 103. In this example, the robot 101 includes a mounting base 104, a first arm 106, and a second arm 108 that can be moved and/or rotated relative to the first arm 106. The example applicator 102 includes a tool interface (e.g., a tool holder, a mount, an arm interface, a tool changer, etc.) 110, and an end effector (e.g., a rotatable end effector, a movable end effector, etc.) 112 that is couplable to the robot 101 (e.g., couplable to the second arm 108). In turn, the end effector 112 of the illustrated example supports a syringe 114 and includes an interface portion 116, which may be 3-D printed, for example. In this example, the syringe 114 is fluidly coupled to a fluid source 118, which can be pressurized with a liquid dispenser, for example. According to some examples disclosed herein, the fluid dispensing and shaping system 100 includes or is communicatively coupled to at least one controller 120, at least one sensor 122, as well as a human machine interface (HMI) 123. The controller(s) 120 can include at least one of a robot controller or a programmable logic controller (PLC) controller.

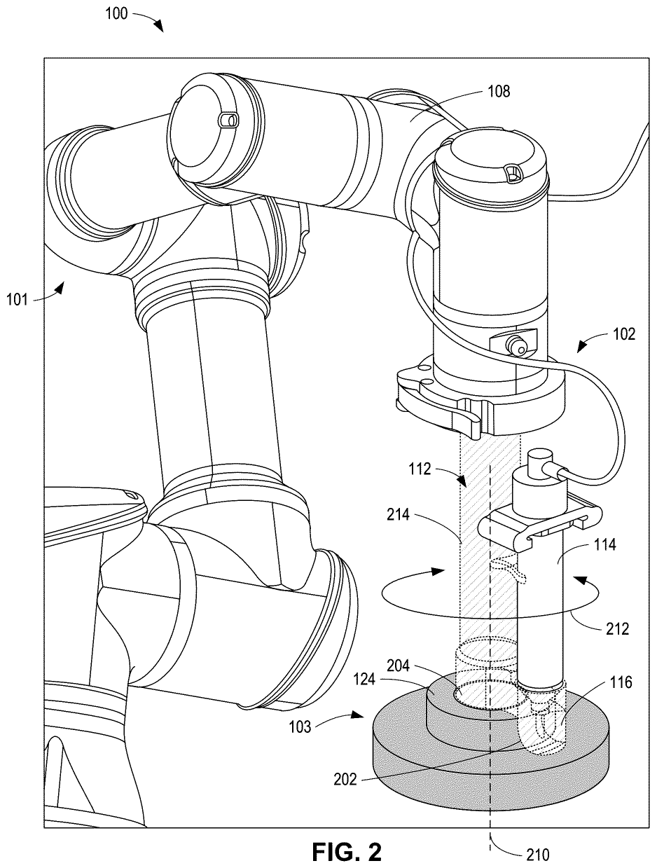

In operation, as will be discussed in further detail below in connection with FIGS. 2-7, fluid is dispensed and/or ejected from the interface portion 116 of the end effector 112 while the end effector 112 rotates, thereby forming a structure or body of the fluid to at least partially surround a flange 124 of the workpiece 103. According to examples disclosed herein, the movement of the end effector 112 shapes the dispensed fluid. As a result, the fluid can form a seal having a solid portion and/or object that would be otherwise difficult to accurately produce with conventional techniques. In other words, examples disclosed herein can produce accurately controlled structures that are formed by an application of fluid while reducing voids or other defects. Further, examples disclosed herein enable sealant applications that mitigate corrosion and can also reduce (e.g., eliminate) moisture ingression.

According to examples disclosed herein, the example controller(s) 120 of the fluid dispensing and shaping system 100 incorporates a master PLC controller or a computing device (e.g., a PC) with specialized software. In some such examples, the master PLC controller is coupled to a robot controller to direct the fluid dispensing and shaping system 100 (e.g., an entirety of the fluid dispensing and shaping system 100), including, but not limited to, safety systems, rotary table control, etc. In other words, the master PLC controller can act as an overall coordinator of the fluid dispensing and shaping system 100, for example.

FIG. 2 is a detailed view of the example fluid dispensing and shaping system 100 of FIG. 1. In the illustrated example of FIG. 2, the applicator 102 of the robot 101 is operated to place and/or align the end effector 112 relative to the workpiece 103 via movement of the second arm 108 and/or the first arm 106. In this example, at least a portion (or an alignment feature) of the end effector 112 is aligned with and/or inserted into an aperture of the workpiece 103. Additionally or alternatively, geometric features or structures of the end effector 112 are utilized to align the end effector to the workpiece 103. According to some examples disclosed herein, the second arm 108 and/or the first arm 106 move the end effector 112 during dispensing of fluid from the interface portion 116 of the end effector 112.

To define and/or build a structure (formed by application of the fluid) with a swept and/or revolved cross-sectional profile that at least partially surrounds the aforementioned flange 124 of the workpiece 103, the end effector 112 dispenses high viscosity fluid (e.g., sealant, adhesive, etc.) from the syringe 114 (e.g., via the interface portion) to the workpiece 103 while the end effector 112 is rotated along its axis of rotation 210, as generally indicated by a double arrow 212. In this example, the axis of rotation 210 is generally aligned with a center axis and/or centroid of a cylindrical portion or stem 214 of the end effector 112. According to examples disclosed herein, the interface portion 116 of the end effector 112 is radially spaced from the axis of rotation 210, and includes a contoured surface (e.g., a shaping surface, a curved surface, a curved bladder, etc.) 202 to define at least one curved surface and/or contour of the structure formed by shaping of the applied fluid (e.g., as the applied fluid is cured). In other words, the end effector 112 dispenses and shapes the fluid dispensed therefrom. In this example, the workpiece 103 includes a central aperture 204, which may be used as an alignment feature or reference for aligning the end effector 112 and, in turn, the interface portion 116 of the end effector 112 relative to the workpiece 103.

In some examples, the interface portion 116 of the end effector 112 is positioned at a gap to the workpiece 103 as the fluid is dispensed therefrom. In some examples, the highly viscous fluid is generally constrained by the contoured surface to shape the dispensed fluid. While examples disclosed herein are shown in the context of a rotational motion, examples disclosed herein can move the interface portion 116 in a sweeping motion, a pivoting motion, a translating motion, etc.

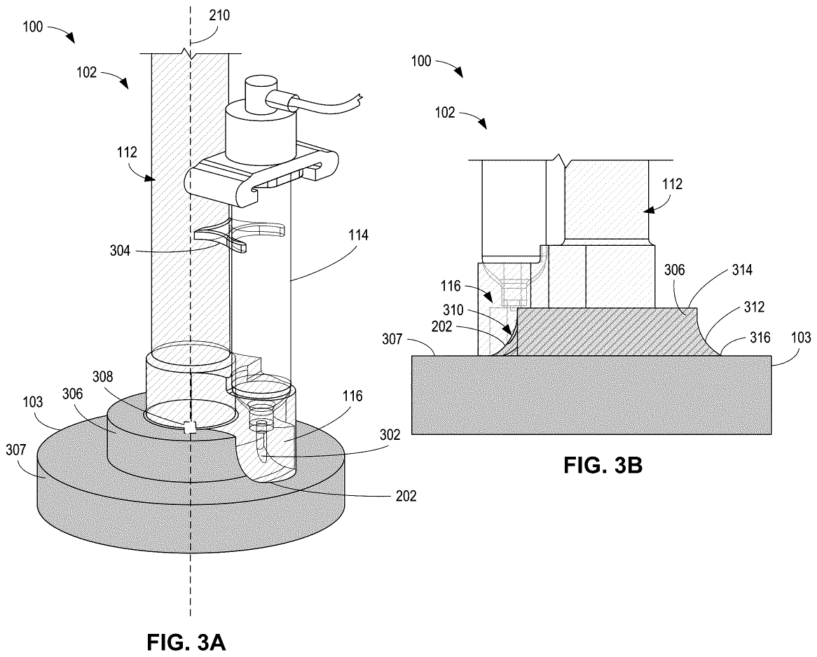

FIGS. 3A and 3B are detailed views of the example fluid dispensing and shaping system 100 of FIGS. 1 and 2. Turning to FIG. 3A, a detailed view of a portion of the applicator 102 is shown. In the illustrated example of FIG. 3A, the example end effector 112 is shown having the corresponding interface portion 116 with the contoured surface 202 positioned proximate the workpiece 103 and the end effector 112 having a tab (e.g., spring arms, elastic tabs, etc.) 304 to position, hold and support the syringe 114. In the illustrated example of FIG. 3A, the interface portion 116 is positioned radially away from the axis of rotation 210 and also at a lateral/radial distance to a flange 306 of the workpiece 103 due to movement/positioning of the first and second arms 106, 108 shown in FIGS. 1 and 2. In this example, the end effector 112 dispenses and/or ejects the fluid from a dispensing outlet (e.g., a dispensing channel, an outlet channel, etc.) 302 to an outer diameter of the flange 306 while the end effector 112 is rotated about the axis of rotation 210, thereby defining an applied structure with a swept/rotated cross-sectional profile. As a result, the applied structure spans between the flange 306 and a base (e.g., a base portion) 307 of the workpiece 103.

In some examples, at least a portion of the end effector 112 and/or the interface portion 116 is inserted into an aperture of the workpiece 103 (e.g., an aperture that spans the flange 306 and the base 307) to align the end effector 112 and, in turn, the interface portion 116 relative to the workpiece 103. In other examples, a portion 308 of the workpiece (e.g., a protrusion of the workpiece 103, an extension of the workpiece 103, etc.) is inserted into the end effector 112 and/or the interface portion 116 to align the end effector 112 relative to the workpiece 103 as the fluid is applied to the flange 306 of the workpiece 103. Additionally or alternatively, the end effector 112 is aligned relative to the workpiece 103 based on markers and/or reference indicators (e.g., targets, symbols, crosshairs, etc.) for control of movement of the end effector 112 (e.g., via automated alignment control).

FIG. 3B depicts the example end effector 112 of the applicator 102 with an applied structure (e.g., an applied body, an applied component, etc.) 310 formed onto the workpiece 103 by dispensing fluid from the interface portion 116 of the end effector 112. In this example, the applied structure 310 is a swept/rotated applied structure that includes a contoured/curved portion (e.g., a contoured/curved surface, concave surface, etc.) 312 that extends between a first surface 314 and a second surface 316 (of the base 307) that is relatively flat (e.g., a flat upper surface) to support the applied structure 310 with respect to the workpiece 103. In this example, the first surface 314 aligns with a top surface (in the view of FIG. 3B) of the flange 306 of the workpiece 103.

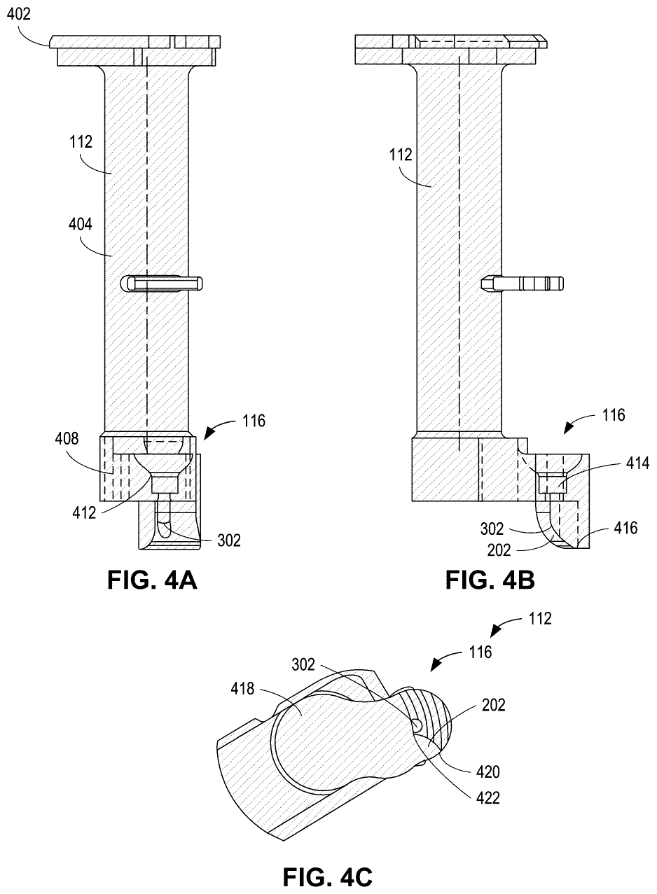

FIGS. 4A-4C are detailed views of the example applicator 102 in accordance with teachings of this disclosure. Turning to FIG. 4A, the end effector 112 is depicted. The example end effector 112 includes a coupling portion (e.g., an arm coupling portion, a mounting portion, etc.) 402, a cylindrical portion 404 and a collar 408 to support and/or align the interface portion 116 (of the end effector 112) defining the outlet 302. In this example, the outlet 302 is fluidly coupled to a converging portion (e.g., a nozzle portion, etc.) 412, which can be implemented to align at least a portion of or compress against the syringe 114 shown in FIGS. 1-3B.

FIG. 4B is a detailed view of the end effector 112 of the applicator 102. In this example, the interface portion 116 of the end effector 112 includes the aforementioned contoured surface 202. As can be seen in the illustrated example of FIG. 4B, the contoured surface 202 includes a generally arcuate shape and may be defined by a combination of splines or other geometric features (e.g., arc splines, straight facets, corners, etc.). In the illustrated view of FIG. 4B, the example contoured surface 202 spans across a longitudinal distance of the applicator 102. Further, the interface portion 116 of the end effector 112 can receive and/or interface with a tip of the syringe 114 shown in FIGS. 1-3B. However, any other appropriate interface and/or geometry can be implemented instead. In some examples, the outlet 302 is positioned away, inset and/or offset from the contoured surface 202. In some examples, the interface portion 116 includes a bed 414 to support a syringe tip (e.g., via an interference fit of the syringe tip). In some examples, the interface portion 116 includes a distal end (e.g., a converging end, etc.) 416 to contact and/or interface with a workpiece, such as the workpiece 103.

FIG. 4C is a detailed partial cutaway view of the interface portion 116 of the end effector 112. In this example, the interface portion 116 of the end effector 112 includes and/or defines a curved bladder 418 with a converging tip 420. According to examples disclosed herein, the curved bladder 418 and the converging tip 420 are defined by a shape of the curved surface 202. In this example, contact of the contoured surface 202 with the fluid as the fluid is applied enables a cone-shaped ring (e.g., a cone with an aperture) structure resembling a volcano to be formed from the applied fluid, which can be advantageous from a strength-to-weight perspective, and particularly useful in aircraft applications, such as rotors, for example. While a cone-shaped formed structure is described in connection with this example, any appropriate other formed structure shape can be formed including, but not limited to, a cone, a sharp edge, a chamfer, a hole or a radius, etc. According to some examples disclosed herein, the structure formed from the applied fluid may be a concave surface ring with a central aperture longitudinally extending therethrough. In this example, the outlet 302 is placed proximate (e.g., above in the view of FIG. 4C) a transition or inflection point, portion or edge 422. However, the outlet 302 can be positioned on any other appropriate portion of the curved bladder 418.

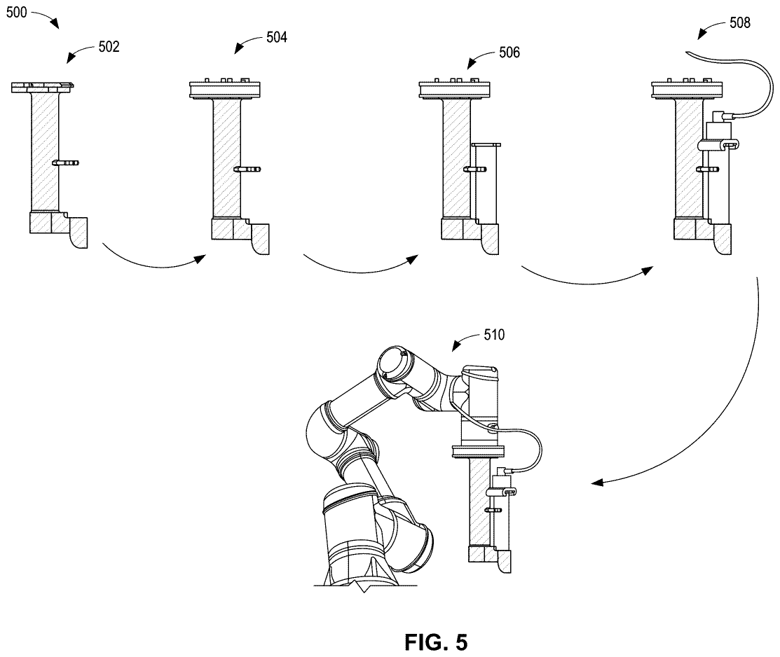

FIG. 5 depicts an example manufacturing process flow 500 that can be implemented in examples disclosed herein. The example process flow 500 can be utilized for an applicator (e.g., the applicator 102) of a robot (e.g., in a manufacturing environment) to apply/dispense high viscosity fluid, such as a sealant, for example. In this example, at block 502, an end effector (e.g., the end effector 112) is placed and/or positioned onto a robot arm for use in applying fluid from the applicator via a tool interface.

At block 504, a manual tool changer/adapter is installed. The manual tool changer/adapter can be utilized to rotationally couple the end effector of the applicator to a robot arm that can be moved, rotated and/or articulated in multiple directions and/or degrees of freedom.

At block 506, a syringe (e.g., the syringe 114) containing premix frozen sealant is installed to the aforementioned end effector. In this example, a claw-like support of the stem is utilized to support the stem.

At block 508, a syringe adapter and/or tube is coupled to the syringe. In some examples, the adapter is utilized to operatively couple a pressurized fluid dispenser to the syringe.

At block 510 the applicator is applied to a robot and/or arm of the robot. In this example, the applicator is movable by the robot in multiple degrees of freedom.

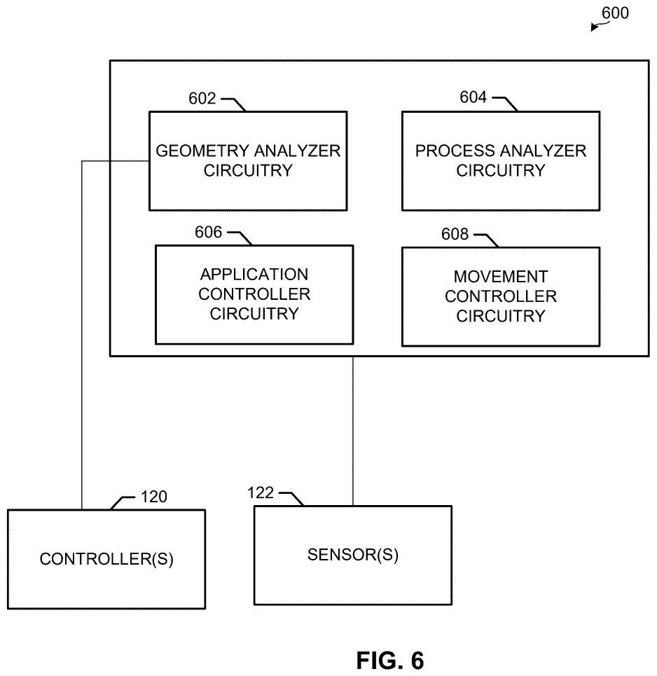

FIG. 6 is a block diagram of an example fluid dispensing control system 600 to control dispensing of fluid for application to a workpiece. The fluid dispensing control system 600 of FIG. 6 may be instantiated (e.g., creating an instance of, bring into being for any length of time, materialize, implement, etc.) by programmable circuitry such as a Central Processor Unit (CPU) executing first instructions. Additionally or alternatively, the fluid dispensing control system 600 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

The fluid dispensing control system 600 of the illustrated example includes example geometry analyzer circuitry 602, example process analyzer circuitry 604, example application controller circuitry 606, and example movement controller circuitry 608. In some examples, the fluid dispensing control system 600 includes and/or is communicatively coupled to the controller(s) 120 and/or the sensor(s) 122. Alternatively, the dispensing control system 600 is implemented in the controller(s) 120.

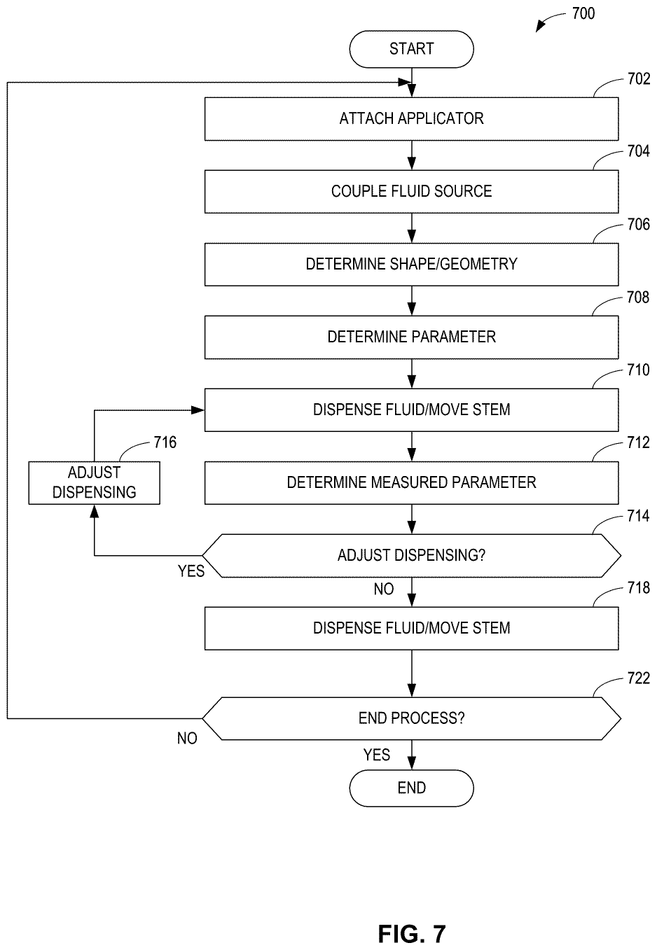

According to examples disclosed herein, the geometry analyzer circuitry 602 is implemented to determine a movement (e.g., rotation, translation, pivoting, etc.) of an arm of the robot and/or an end effector to generate a desired shape of a produced structure resulting from fluid dispensed from an outlet of the end effector. In some examples, the geometry analyzer circuitry 602 is instantiated by programmable circuitry executing geometry analyzer instructions and/or configured to perform operations such as those represented by the flowchart of FIG. 7.

In this example, the process analyzer circuitry 604 is implemented to determine and/or calculate steps and/or processing of dispensed fluid to form a desired shape of a produced structure (e.g., with applied high viscosity sealant). In some examples, the process analyzer circuitry 604 is instantiated by programmable circuitry executing process analyzer instructions and/or configured to perform operations such as those represented by the flowchart of FIG. 7.

In the illustrated example of FIG. 6, the example application controller circuitry 606 is implemented to adjust the dispensing of fluid from an end effector carried by the arm and/or the robot. For example, the application controller circuitry 606 can control, adjust and/or maintain a flow rate and/or a pressure of the fluid being dispensed from the end effector. Additionally or alternatively, the example application controller circuitry 606 controls a rate of rotation and/or movement of the end effector (e.g., via movement of the arm). In some examples, the application controller circuitry 606 is instantiated by programmable circuitry executing application controller instructions and/or configured to perform operations such as those represented by the flowchart of FIG. 7.

In this example, the movement controller circuitry 608 is implemented to adjust and/or vary operation of the robot, the arm and/or the end effector based on at least one parameter measured during operation of the robot. The at least one parameter may be measured from a sensor, such as a flow rate sensor corresponding to the fluid or a sensor that measures a pressure of the fluid, for example. According to some examples disclosed herein, the movement controller circuitry 608 controls and/or maintains a distance (e.g., a gap) between the end effector and the workpiece to facilitate a flow of the fluid between the end effector and the workpiece. In some examples, the movement controller circuitry 608 is instantiated by programmable circuitry executing movement controller instructions and/or configured to perform operations such as those represented by the flowchart of FIG. 7.

While an example manner of implementing the fluid dispensing control system 600 of FIG. 6 is illustrated in FIG. 6, one or more of the elements, processes, and/or devices illustrated in FIG. 6 may be combined, divided, re-arranged, omitted, eliminated, and/or implemented in any other way. Further, the example geometry analyzer circuitry 602, the example process analyzer circuitry 604, the example application controller circuitry 606, the example movement controller circuitry 608, and/or, more generally, the example fluid dispensing control system 600 of FIG. 6, may be implemented by hardware alone or by hardware in combination with software and/or firmware. Thus, for example, any of the example geometry analyzer circuitry 602, the example process analyzer circuitry 604, the example application controller circuitry 606, the example movement controller circuitry 608, and/or, more generally, the example fluid dispensing control system 600, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example fluid dispensing control system 600 of FIG. 6 may include one or more elements, processes, and/or devices in addition to, or instead of, those illustrated in FIG. 6, and/or may include more than one of any or all of the illustrated elements, processes and devices.

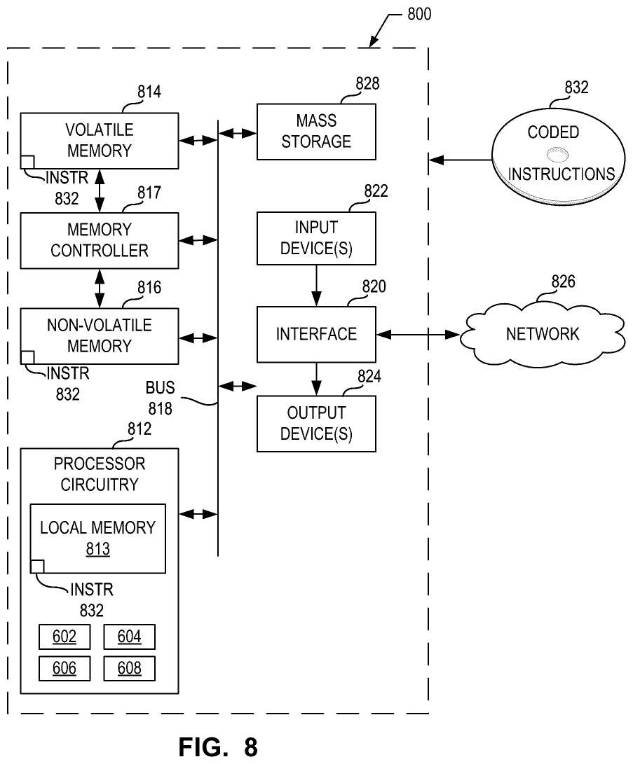

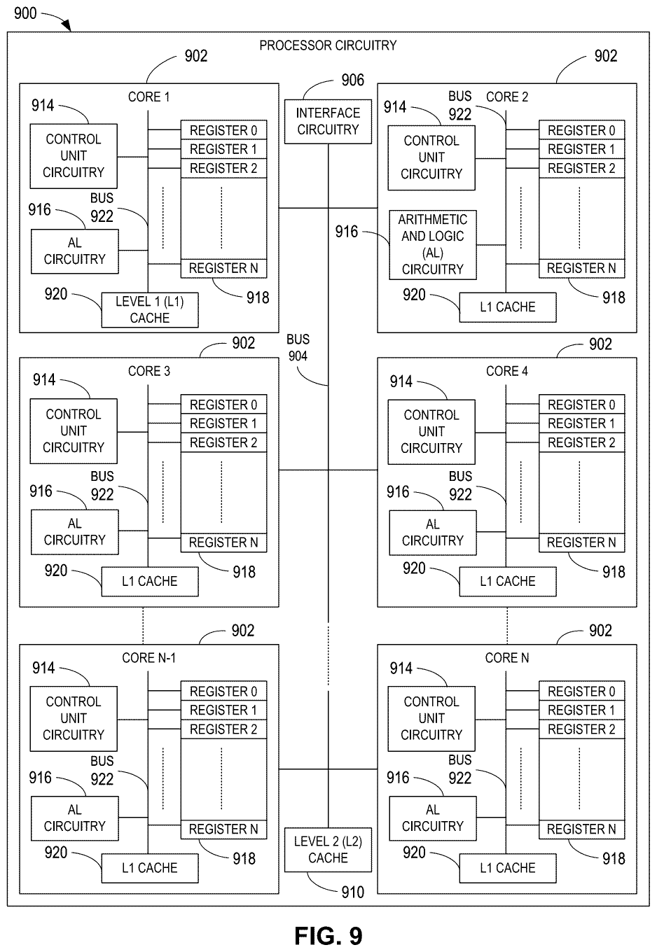

A flowchart representative of example machine readable instructions, which may be executed by programmable circuitry to implement and/or instantiate the fluid dispensing control system 600 of FIG. 6 and/or representative of example operations which may be performed by programmable circuitry to implement and/or instantiate the fluid dispensing control system 600 of FIG. 6, is shown in FIG. 7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 7, many other methods of implementing the example fluid dispensing control system 600 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to control operation of a fluid applicator that applies high viscosity material. The example machine-readable instructions and/or the example operations 700 of FIG. 7 begin at block 702, at which an applicator is attached and/or coupled to a robot arm. In this example, the applicator and/or the robot arm includes an end effector mounted/coupled thereto. Further, the example end effector is rotatably coupled to the robot arm.

At block 704, a fluid source is coupled to the applicator. In this example, the fluid source is part of and/or fluidly coupled to a syringe that is supported by a rotatable end effector of the robot arm. In some examples, the syringe is placed into arms/claws for alignment and/or positioning. The syringe can be pressurized and/or provided with a pressurized fluid to facilitate dispensing/ejection of the fluid.

At block 706, the geometry analyzer circuitry 602 determines a desired shape and/or geometry of the applied fluid. For example, the geometry analyzer circuitry 602 may determine an overall cross-sectional profile (e.g., a swept or revolved cross-sectional profile) of the applied fluid to define a desired shape. The cross-sectional profile may include a geometry that is swept (along a trajectory) or revolved about an axis, for example.

At block 708, the example process analyzer circuitry 604 determines at least one process parameter based on the determined shape and/or geometry. In some examples, the process analyzer circuitry 604 determines a clearance of the end effector to a workpiece during dispensing/ejection of the fluid to a workpiece, a flow rate profile and/or a pressure profile of the fluid to be applied as the end effector and/or the arm is moved.

At block 710, the example application controller circuitry 606 causes the applicator to dispense/eject the fluid via the end effector as the end effector is moved. In this example, the end effector includes at least one contoured surface that is shaped such that movement thereof in combination with contact of the dispensed/applied fluid defines a geometry of an object, component and/or structure from the dispensed/applied fluid. In this particular example, the end effector supported by the robot arm is rotated about an axis of rotation that is colinear/aligned with a center axis of a cylindrical portion thereof. In some examples, the end effector is moved by at least one of the arms to maintain a gap (e.g., a clearance space) between an outlet of the end effector and the workpiece.

At block 712 the example process analyzer circuitry 604 and/or the example application controller circuitry 606 determines a measured parameter of the application of the fluid based on output from a sensor. The sensor can be a flow rate sensor associated with dispensing the fluid.

At block 714, the example process analyzer circuitry 604 and/or the example application controller circuitry 606 determines whether to adjust the dispensing of the fluid. If the dispensing is to be adjusted (block 714), control of the process proceeds to block 716. Otherwise, the process proceeds to block 718.

At block 716, the application controller circuitry 606 adjusts the dispensing of the fluid. In some examples, the application controller circuitry 606 adjusts a temperature, a flow rate and/or a pressure of the fluid dispensed from the end effector (e.g., based on the measured parameter and/or output from the aforementioned sensor). Additionally or alternatively, the application controller circuitry 606 adjusts positioning and/or an orientation of the end effector.

At block 718, the example application controller circuitry 606 causes (or continues to cause) the fluid to be dispensed from the outlet of the end effector while the end effector is moved. In this example, the application controller circuitry 606 causes the fluid to exit the syringe supported by the end effector (e.g., the syringe is supported by claws/arms extending from a cylindrical portion/stem of the end effector) and flow toward the outlet of the end effector.

At block 722, the example process analyzer circuitry 604 and/or the example application controller circuitry 606 determines whether to repeat the process. If the process is to be repeated (block 722), control of the process returns to block 702. Otherwise, the process ends. The determination may be based on whether additional applications of fluid are to be applied to the part, whether additional parts are to be applied with fluid, etc.

FIG. 8 is a block diagram of an example programmable circuitry platform 800 structured to execute and/or instantiate the example machine-readable instructions and/or the example operations of FIG. 7 to implement the fluid dispensing control system 600 of FIG. 6. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example geometry analyzer circuitry 602, the example process analyzer circuitry 604, the example application controller circuitry 606, and the example movement controller circuitry 608.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIG. 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowchart of FIG. 7 to effectively instantiate the circuitry of FIG. 6 as logic circuits to perform operations corresponding to those machine readable instructions. In some such examples, the circuitry of FIG. 6 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

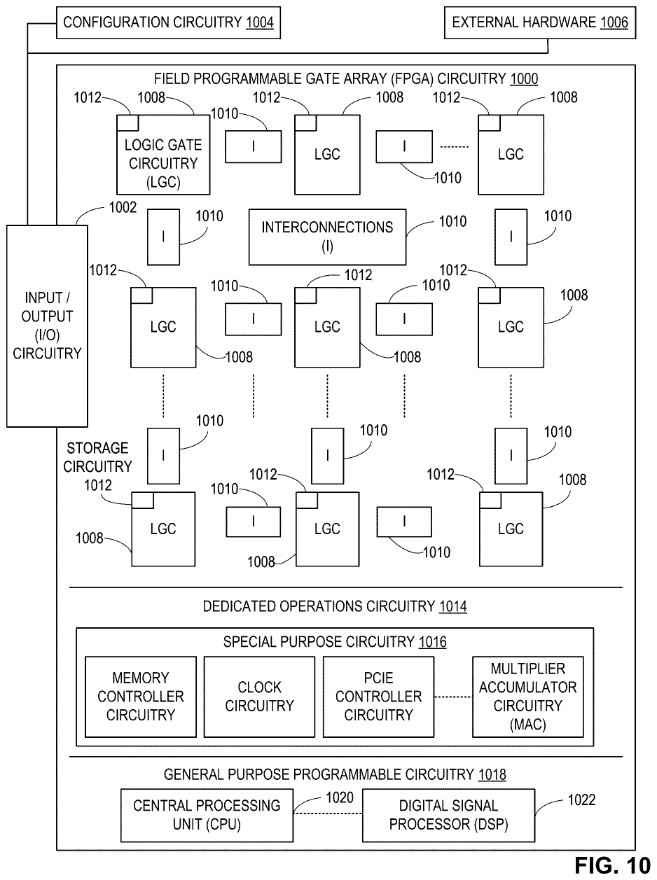

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart of FIG. 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart of FIG. 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 7. As such, the FPGA circuitry 1000 may be configured and/or structured to effectively instantiate some or all of the operations/functions corresponding to the machine readable instructions of the flowchart of FIG. 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIG. 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIG. 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIG. 9 and10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart of FIG. 7 to perform first operation(s)/function(s), the FPGA circuitry 1000 of FIG. 10 may be configured and/or structured to perform second operation(s)/function(s) corresponding to a second portion of the machine readable instructions represented by the flowchart of FIG. 7, and/or an ASIC may be configured and/or structured to perform third operation(s)/function(s) corresponding to a third portion of the machine readable instructions represented by the flowchart of FIG. 7.

It should be understood that some or all of the circuitry of FIG. 6 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 6 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 6 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to enable accurate control of forming components or objects with highly viscous fluids are disclosed herein. Further examples and combinations thereof include the following:

Example 1 includes an applicator comprising a tool interface couplable to an arm of a robot, and an end effector supported by the tool interface, the end effector including a contoured surface and an outlet proximate or on the contoured surface, the outlet to dispense fluid therefrom as the end effector is moved such that contact of the contoured surface with the dispensed fluid is to shape the dispensed fluid.

Example 2 includes the applicator as defined in example 1, wherein the end effector is rotatably couplable to the arm, and wherein the outlet is to dispense the fluid as the end effector is rotated relative to the arm.

Example 3 includes the applicator as defined in example 2, wherein the outlet is spaced apart from an axis of rotation of the end effector.

Example 4 includes the applicator as defined in any of examples 1 or 2, further including interface circuitry communicatively coupled to a sensor, machine-readable instructions, and at least one processor circuit to be programmed by the machine-readable instructions to determine a parameter of the of the fluid dispensed from the end effector based on output from the sensor, and adjust at least one of the dispensing of the fluid or a rate of movement of the arm based on the determined parameter.

Example 5 includes the applicator as defined in example 4, wherein the sensor includes a flow rate sensor to measure a flow rate of the fluid.

Example 6 includes the applicator as defined in any of examples 1 to 5, wherein the contoured surface is to define a concave surface of the dispensed fluid based on movement of the end effector.

Example 7 includes the applicator as defined in any oof examples 1 to 6, wherein the end effector includes a curved bladder shape.

Example 8 includes the applicator as defined in any of examples 1 to 7, wherein the end effector includes an alignment feature for alignment of a workpiece to which the fluid is applied from the end effector.

Example 9 includes the apparatus as defined in any of examples 1 to 8, wherein the fluid dispensed from the end effector includes a sealant to be applied to an outer diameter of a flange of a workpiece.

Example 10 includes a non-transitory machine readable storage medium comprising instructions to cause programmable circuitry to at least determine a parameter of fluid being dispensed from an end effector based on output from a sensor, the end effector supported by a robot arm, the end effector having a contoured surface to shape the dispensed fluid as the end effector is moved, and adjust at least one of the dispensing of the fluid or a rate of movement of the end effector based on the determined parameter.

Example 11 includes the machine readable storage medium as defined in example 10, wherein the instructions cause one or more of the programmable circuitry to cause the robot arm to place at least a portion of the end effector into an aperture of a workpiece to which the fluid is dispensed from the end effector.

Example 12 includes the machine readable storage medium as defined in any of examples 10 or 11, wherein the instructions cause one or more of the programmable circuitry to adjust a rate of rotation of the end effector based on the determined parameter.

Example 13 includes the machine readable storage medium as defined in any of examples 10 to 12, wherein the instructions cause one or more of the programmable circuitry to control movement of the robot arm to maintain a gap between the end effector and a workpiece to which the fluid is applied as the fluid is dispensed from the end effector.

Example 14 includes the machine readable storage medium as defined in any of examples 10 to 13, wherein the instructions cause one or more of the programmable circuitry to control a dispensing of the fluid from a syringe supported by the end effector to maintain a pressure of the dispensed fluid as the end effector is moved.

Example 15 includes the machine readable storage medium as defined in any of examples 10 to 14, wherein the instructions cause one or more of the programmable circuitry to control a rate of rotation of the end effector with respect to the robot arm based on the determined parameter.

Example 16 includes the machine readable storage medium as defined in any of examples 10 to 15, wherein the parameter is a flow rate of the dispensed fluid from the end effector.

Example 17 includes a method comprising moving an end effector supported by an arm of a robot, and dispensing fluid from an outlet of the end effector, the end effector including a contoured surface proximate the outlet to contact the dispensed fluid to define a swept or rotated shape object of the fluid.

Example 18 includes the method as defined in example 17, further including rotating the end effector relative to the arm, the outlet of the end effector spaced apart from an axis of rotation of the end effector.

Example 19 includes the method as defined in any of examples 17 or 18, further including inserting a portion of the end effector into an aperture of a workpiece to which the fluid is applied.

Example 20 includes the method as defined in any of examples 17 to 19, wherein the dispensed fluid is to define a formed structure including at least one of a cone, a sharp edge, a chamfer, a hole or a radius, the formed structure positioned on a workpiece.

From the foregoing, it will be appreciated that example systems, apparatus, articles of manufacture, and methods have been disclosed that improve ergonomics, safety, precision, and efficiency with respect to application of fluids, including, but not limited to, highly viscous fluids, such as sealants. Examples disclosed herein can greatly improve control of application of the fluids and, thus, the resultant components formed therefrom. Further, examples disclosed herein can reduce waste in dispensing of the fluids.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An applicator comprising:
a tool interface couplable to an arm of a robot; and
an end effector supported by the tool interface, the end effector including a contoured surface and an outlet proximate or on the contoured surface, the outlet to dispense fluid therefrom as the end effector is moved such that contact of the contoured surface with the dispensed fluid is to shape the dispensed fluid.

2. The applicator as defined in claim 1, wherein the end effector is rotatably couplable to the arm, and wherein the outlet is to dispense the fluid as the end effector is rotated relative to the arm.

3. The applicator as defined in claim 2, wherein the outlet is spaced apart from an axis of rotation of the end effector.

4. The applicator as defined in claim 1, further including:
interface circuitry communicatively coupled to a sensor;
machine-readable instructions; and
at least one processor circuit to be programmed by the machine-readable instructions to:
determine a parameter of the of the fluid dispensed from the end effector based on output from the sensor; and
adjust at least one of the dispensing of the fluid or a rate of movement of the end effector based on the determined parameter.

5. The applicator as defined in claim 4, wherein the sensor includes a flow rate sensor to measure a flow rate of the fluid.

6. The applicator as defined in claim 1, wherein the contoured surface is to define a concave surface of the dispensed fluid based on movement of the end effector.

7. The applicator as defined in claim 1, wherein the end effector includes a curved bladder shape.

8. The applicator as defined in claim 1, wherein the end effector includes an alignment feature for alignment of a workpiece to which the fluid is applied from the end effector.

9. The applicator as defined in claim 1, wherein the fluid dispensed from the end effector includes a sealant to be applied to an outer diameter of a flange of a workpiece.

10. A non-transitory machine readable storage medium comprising instructions to cause programmable circuitry to at least:
determine a parameter of fluid being dispensed from an end effector based on output from a sensor, the end effector supported by a robot arm, the end effector having a contoured surface to shape the dispensed fluid as the end effector is moved; and
adjust at least one of the dispensing of the fluid or a rate of movement of the end effector based on the determined parameter.

11. The machine readable storage medium as defined in claim 10, wherein the instructions cause one or more of the programmable circuitry to cause the robot arm to place at least a portion of the end effector into an aperture of a workpiece to which the fluid is dispensed from the end effector.

12. The machine readable storage medium as defined in claim 10, wherein the instructions cause one or more of the programmable circuitry to adjust a rate of rotation of the end effector based on the determined parameter.

13. The machine readable storage medium as defined in claim 10, wherein the instructions cause one or more of the programmable circuitry to control movement of the robot arm to maintain a gap between the end effector and a workpiece to which the fluid is applied as the fluid is dispensed from the end effector.

14. The machine readable storage medium as defined in claim 10, wherein the instructions cause one or more of the programmable circuitry to control a dispensing of the fluid from a syringe supported by the end effector to maintain a pressure of the dispensed fluid as the end effector is moved.

15. The machine readable storage medium as defined in claim 10, wherein the instructions cause one or more of the programmable circuitry to control a rate of rotation of the end effector with respect to the robot arm based on the determined parameter.

16. The machine readable storage medium as defined in claim 10, wherein the parameter is a flow rate of the dispensed fluid from the end effector.

17. A method comprising:
moving an end effector supported by an arm of a robot; and
dispensing fluid from an outlet of the end effector, the end effector including a contoured surface proximate the outlet to contact the dispensed fluid to define a swept or rotated shape object of the fluid.

18. The method as defined in claim 17, further including rotating the end effector relative to the arm, the outlet of the end effector spaced apart from an axis of rotation of the end effector.

19. The method as defined in claim 17, further including inserting a portion of the end effector into an aperture of a workpiece to which the fluid is applied.

20. The method as defined in claim 17, wherein the dispensed fluid is to define a formed structure including at least one of a cone, a sharp edge, a chamfer, a hole or a radius, the formed structure positioned on a workpiece.
